(19) United States
(12) Patent Application Publication
(10) Pub. No.: US 2026/0042639 A1
(43) Pub. Date: Feb. 12, 2026

(54) PASSENGER TRANSPORT SYSTEM AND METHOD FOR TRANSPORTING A PASSENGER

(71) Applicant: Inventio AG, Hergiswil (CH)

(72) Inventors: Eliza Olczyk, Horw (CH); Thomas Raber, Luzern (CH); Oliver Simmonds, Luzern (CH); Raphael Bitzi, Luzern (CH); Qixuan Zhang, Thalwil (CH)

(21) Appl. No.: 19/101,005

(22) PCT Filed: Aug. 3, 2023
(86) PCT No.: PCT/EP2023/071512

§ 371 Date: Feb. 4, 2025

(30) Foreign Application Priority Data
Aug. 11, 2022 (EP) 22190013.7

(51) Int. Cl. B66B 9/00; B62D 63/02; B66B 11/00

(52) U.S. Cl. CPC B66B 9/003; B62D 63/025; B66B 11/006

(57) ABSTRACT

A passenger transport system and a method for transporting a passenger include a cabin transported by a transport vehicle, the cabin accommodating at least one passenger. The transport vehicle and the cabin are coupled and decoupled such that the cabin is transported when coupled to the transport vehicle. The passenger transport system also has a movement device attached to a building and which is coupled to and decoupled from the cabin. The cabin, when coupled to the movement device, is moved relative to the building by the movement device on a first main movement path and on a second main movement path.

### FIELD

The invention relates to a passenger transport system having a cabin or module for accommodating at least one passenger, wherein the cabin can be coupled and uncoupled to be transported by a transport vehicle or by a movement device connected to a building, and a method for transporting a passenger using the passenger transport system.

### BACKGROUND

WO 2019/224111 A1 describes a passenger transport system with a transport vehicle in the form of a road vehicle and a cabin or module for accommodating at least one passenger. The transport vehicle and the cabin can be coupled and decoupled so that in a state coupled to the transport vehicle the cabin can be transported by the transport vehicle with a passenger in the cabin. The transport vehicle can transport the cabin to any location, and hence also to a building. WO 2019/224111 A1 thus also describes a method for transporting a passenger in a cabin, wherein the cabin is coupled to a transport vehicle and transported to a building by the transport vehicle with the passenger.

EP 0842888 A1 also describes such a passenger transport system with a transport vehicle and a cabin. The cabin can be transported by the transport vehicle to a building and then transferred to a platform of an elevator arranged in the building. By means of the elevator, the cabin can be moved vertically within the building.

JP H06156939 A describes an elevator with two vertical elevator shafts in which cabins can be moved. The cabins can be moved between the two elevator shafts by means of a transport vehicle. The cabins can therefore move from one elevator shaft to the other.

### SUMMARY

It is in particular an object of the invention to propose a passenger transport system and a method for transporting a passenger, which can quite conveniently bring the transported passenger very close to his destination in a building. According to the invention, this object is achieved by a passenger transport system and a method having the features described below.

The passenger transport system according to the invention is provided for a cabin transportable by a transport vehicle for accommodating at least one passenger, wherein the transport vehicle and the cabin can be coupled and uncoupled so that the cabin can be transported by the transport vehicle in a state coupled to the transport vehicle. The passenger transport system has a movement device connected to a building. The movement device and the cabin can be coupled and decoupled so that the cabin, in a state coupled to the movement device, can be moved by the movement device relative to the aforementioned building on a first main movement path. This means that a passenger who has been transported in a cabin by the transport vehicle to a building in which his destination, for example his apartment, is located can be transported within or along a building onward toward his destination without having to get out of the cabin. The cabin and therefore the passenger can, for example, be moved by the movement device along an outer side of the building to the apartment of the passenger so that the passenger can get out of the cabin directly into his apartment. If the passenger wants to start a journey within the building, for example in his apartment, he can very conveniently get into a cabin provided by the movement device at or in the building. Starting a journey inside a building is therefore also very convenient for a passenger, and he can get into the cabin very close to his starting point.

According to the invention, the movement device has, in addition to the first main movement path, a second main movement path on which the cabin can be moved, wherein the aforementioned main movement paths have different main movement directions. This allows the movement device to flexibly move the cabin within the building or along the building and to bring the passenger in the cabin very close to his destination in the building.

In particular, the movement device has in particular not only one second main movement path, but also a plurality of second main movement paths which in particular all have the same main movement direction. The second main movement path or the second main movement paths run in particular horizontally; the main movement direction of the second main movement path therefore also runs horizontally. However, the second main movement path or the second main movement paths can also have a different main movement direction. In particular, they run straight, but they can also be not straight, for example curved.

In particular, the movement of the cabin on the second main movement path or second main movement paths is also guided, with the guidance being configured in a similar way to the guidance on the first main movement path.

The passenger transport system according to the invention can transport not only people but also goods, such as luggage or purchases of the passenger. It is therefore not just limited to pure passenger transport.

The transport vehicle can, for example, be designed as a land vehicle, an aircraft or a watercraft. In particular, it is designed as an autonomous transport vehicle so that it manages without a vehicle driver or person at the controls. However, it is also possible for the transport vehicle to be controlled by a vehicle driver specially designated for this purpose or by a passenger in the cabin. The transport vehicle can transport one or even a plurality of cabins at the same time.

A transport vehicle designed as a land vehicle can, for example, be designed as a road vehicle, i.e. a vehicle driving on roads. It is also possible for the land vehicle to be designed as a rail vehicle, i.e. a vehicle running on rails, i.e., similar to a railroad. In this case, it is in particular conceivable that the rail vehicle transports more than one cabin. An aircraft can, for example, be designed as a vertical take-off and landing (VTOL) aircraft, in particular as a drone.

In particular, the cabin is designed to be driveless; in other words, it does not have its own drive. However, it is also conceivable for the cabin to have a simple drive and, for example, extendable rollers so that the cabin can cover short distances on its own, i.e. without the transport vehicle or the movement device. The cabin can be designed to transport a single passenger or also to transport several people.

The coupling of the transport vehicle and the cabin or the movement device and the cabin should be understood here as a physical coupling and not just an IT coupling. The aforementioned coupling can be mechanical, magnetic or by means of negative pressure, for example. The transport vehicle and the cabin as well as the movement device and the cabin have, in particular, corresponding coupling components, wherein the transport vehicle has at least one vehicle-side coupling component, the movement device has at least one device-side coupling component and the cabin has at least one cabin-side coupling component. For example, the cabin can have supports which are enclosed by a controllable gripper of the transport vehicle or the movement device, and a coupling with the cabin can thereby be established. Alternatively, it is possible for the transport vehicle or the movement device to have a controllable electromagnet and the cabin to have a correspondingly positioned magnetizable plate. By activating the electromagnet, a coupling with the cabin can be established. The arrangement of the bars and grippers or the electromagnets and plates can also be reversed. In addition, a person skilled in the art can provide further possible couplings and decouplings of the transport vehicle and cabin or the movement device and the cabin. The type and design of the coupling between the transport vehicle and the cabin or between the movement device and the cabin are not of any further relevance here. The coupling is in particular designed redundantly and therefore safe.

The cabin, in a state coupled to the transport vehicle, can be transported by the transport vehicle, for example driven on a road or flown in the air. In a state decoupled from the transport vehicle, the cabin can be moved or transported relative to a building independently of the transport vehicle, i.e. for example by a movement device connected to the building.

A connection of the movement device to a building is understood here to mean that the movement device is arranged within and/or on a building. The movement device as a whole is therefore arranged immobile in relation to the building in question; only individual components of the movement device are movable in relation to the building. A movement of the cabin relative to the building is understood here to mean that the cabin is moved inside the building or outside along the building. The movement takes place at least on a first main movement path which in particular runs straight but can also be not straight, for example curved. The movement of the cabin is in particular guided, for example by guide rails known from the elevator sector or in corresponding recesses or niches in or on the building. The first main movement path runs in particular in a vertical direction; the main movement direction of the first main movement path therefore also runs vertically. The cabin can therefore be moved by the moving device, in particular in or along the building, from bottom to top and from top to bottom.

In particular, except when changing from the transport vehicle to the movement device or vice versa, the cabin is coupled either to the transport vehicle or to the movement device. The aforementioned change can also be termed a transfer. When the cabin changes from a transport vehicle to the movement device, the cabin is transported in particular from the transport vehicle to a coupling station in which a coupling with the movement device can take place. The cabin is then coupled to the movement device, in particular while still coupled to the transport vehicle. Once this has been successfully completed, the coupling between the cabin and the transport vehicle is released, i.e. the cabin is decoupled from the transport vehicle. The cabin can then be moved relative to the building using the moving device. The changing of the cabin from the movement device to a transport vehicle proceeds in the same way or in reverse order.

It is also possible for the cabin to be removed from the transport vehicle by means of a robot and transported to be coupled to the movement device.

The passenger transport system can comprise a movement device connected to a building or a plurality of movement devices connected to a single building or to different buildings. In particular, it can interact with more than one transport vehicle, wherein the individual transport vehicles can be designed identical or different. The corresponding cabins can likewise be constructed the same or differently. They only need to be able to be coupled and decoupled to a transport vehicle and to a movement device.

The passenger transport system has in particular a central control device which monitors, coordinates and/or controls the individual transport vehicles and the one or more movement devices. The transport vehicles, the cabins and the movement devices in particular have their own control devices which can perform individual functions independently and which are in communication with the central control device and/or other control devices.

In an embodiment of the invention, the movement device has a secondary movement path and in particular a plurality of secondary movement paths for the cabin. A secondary movement path branches off from a main movement path and is designed and arranged in such a way that it can accommodate at least one cabin in such a way that the main movement path from which the corresponding secondary movement path branches off can be used by another cabin if there is an accommodated cabin or a plurality of accommodated cabins in the corresponding secondary movement path. This means that at least one cabin can remain or be parked on a secondary movement path without the parked cabin restricting the use of the movement device. For example, a secondary movement path is arranged in such a way that a passenger can get out of the cabin directly into the corresponding building via a building opening. For example, a passenger can enter his apartment directly from the cabin via a corresponding opening in the building.

If the movement device has only a first main movement path, the secondary movement paths can branch off from the main movement path in such a way that in the region of a floor of the building they run next to the main movement path. A secondary movement path can be arranged to the left and right of the main movement path so that for each floor two cabins can be parked on a secondary movement path.

It is also possible for the movement device to have a secondary movement path on which a plurality of cabins can be parked. The passenger can then, for example, get out of the cabin on the desired floor, and the cabin is then brought onto the aforementioned secondary movement path. The cabin is parked there until it is used again, i.e. to transport a passenger.

If the movement device has a first main movement path and at least one second main movement path, then secondary movement paths branch off in particular from the second main movement path. The secondary movement paths can, for example, branch off upward and/or downward from the second main movement path. It is also possible for the building to have niches at the level of the second main movement path that can receive a cabin. The secondary movement paths then branch off horizontally from the second main movement path in the direction of the building or in the direction of the aforementioned niches.

In an embodiment of the invention, the movement device has a first drive, a second drive, a first device-side coupling component and a second device-side coupling component. By means of the first drive, the first device-side coupling component can be moved on the first main movement path. By means of the second drive, the second device-side coupling component can be moved on the second main movement path. The first device-side coupling component is designed and arranged in such a way that it can be coupled to a first cabin-side coupling component of the cabin. The second device-side coupling component is designed and arranged in such a way that it can be coupled to a second cabin-side coupling component of the cabin. This allows the movement device to move the cabin particularly flexibly relative to the building.

The cabin therefore has two cabin-side coupling components that can be coupled to device-side coupling components. The two cabin-side coupling components can be designed the same or differently. At least one of the device-side coupling components is in particular constructed in the same way as a vehicle-side coupling component so that at least one cabin-side coupling component can be coupled not only to a vehicle-side coupling component but also to a device-side coupling component. This means that the number of cabin-side coupling components required on the cabin can be kept to a minimum.

The device-side coupling components are designed in particular in such a way that they can be coupled to cabin-side coupling components which are arranged at the top, bottom or side of the cabin.

The device-side coupling components are in particular arranged on a frame or a support or are part of a frame or a support. The frame or support is moved with or without a coupled cabin as described above, in particular guided in or along the building. The drives of the movement device can be designed, for example, as a winch, a linear drive or a friction-wheel drive. A winch would be connected at least indirectly to the device-side coupling component via a support means. A linear drive or a friction-wheel drive would be arranged on the aforementioned frame or support.

The cabin is coupled either to the first device-side coupling component or to the second device-side coupling component, except when changing from a movement on the first main movement path to a movement on a second main movement path or vice versa. The aforementioned change can also be termed a transfer. When changing the cabin from the first main movement path to the second main movement path, the cabin is moved to a change position in which a coupling to the second device-side coupling component can take place. The change position can be arranged on the first main movement path. It is also possible for the change position to located on a second main movement path. If there is an existing coupling to the first device-side coupling component, the cabin will then be additionally coupled to the second device-side coupling component. After this has been successfully completed, the coupling of the cabin to the first device-side coupling component is released; the cabin is therefore decoupled from the first drive. The cabin can then be moved relative to the building by the second drive on the second main movement path. Changing the cabin from the second main movement path to the first main movement path takes place in the same way or in reverse order.

In an embodiment of the invention, the movement device has a third drive and a third device-side coupling component. By means of the third drive, the third device-side coupling component can be moved on a secondary movement path. The third device-side coupling component is designed and arranged in such a way that it can be coupled to the first cabin-side coupling component of the cabin. The third device-side coupling component is therefore constructed in the same way as the first device-side coupling component. This means that no additional cabin-side coupling component is required for moving the cabin on a secondary movement path and therefore for bringing the cabin into a parking position on the secondary movement path. This means that the number of cabin-side coupling components required on the cabin can be kept particularly low.

The above statements regarding the first and second drives, as well as the first and second device-side coupling components, apply accordingly to the third drive and the third device-side coupling component.

In an embodiment of the invention, the movement device has a trolley on which the cabin can be placed and moved on a horizontally running main movement path. This allows a horizontal movement of the cabin to be realized particularly easily.

After the cabin has been set down on the trolley, the cabin stands on the trolley, i.e. it is supported on the trolley from above. In particular, the trolley has rollers on which it is downwardly supported on the main movement path. The main movement path is in particular designed in such a way that the trolley is guided while being moved. The aforementioned rollers can, for example, run in corresponding recesses, and/or the trolley is guided by corresponding side faces of the main movement path.

In particular, the trolley has an upwardly oriented device-side coupling component which is coupled to a cabin-side coupling component arranged at the bottom of the cabin during or after being set down on the trolley. The drive for moving the trolley is arranged in particular on the trolley and drives in particular one or more rollers of the trolley. However, it is also possible for the drive to be arranged at a distance from the trolley and be connected to drive the trolley. The drive can, for example, be designed as a winch which is connected to the car by a cable.

The horizontally running main movement path is arranged in particular on the outside of the building, for example as a horizontal projection on the building. The main movement path mentioned can in particular have branches into secondary movement paths which can run upward, downward or toward the building.

An alternative to moving the cabin on a trolley is for the cabin to have extendable and, in particular, drivable wheels so that it can travel on the horizontally running main moving path without the support of a trolley.

In an embodiment of the invention, the second main movement path of the movement device has a movable extension element. The extension element is designed and arranged in such a way that the second main movement path can be extended into a first main movement path by means of the extension element. This allows a change of the cabin from the first main movement path onto the second main movement path and vice versa. This enables an easy change of the cabin from the first onto the second main movement path and vice versa.

The position in which the extension element extends the second main movement path into the first main movement path can be referred to as the active position. The extension element assumes an inactive position when it does not extend into the first main movement path. In its active position on the first main movement path, the extension element therefore defines the change position in which the second device-side coupling component can be coupled to the cabin as described above. The extension element can, for example, be moved horizontally onto the first main movement path by means of a suitable drive or can be pivoted about a horizontally oriented pivot axis onto the first main movement path.

In an embodiment of the invention, the first device-side coupling component of the movement device has a support arm which can be coupled to a first cabin-side coupling component of the cabin arranged on an upper side or on an underside of the cabin. The support arm can be pivoted about a vertically running first pivot axis in such a way that a cabin coupled to the first device-side coupling component can be moved from a first main movement path onto a second main movement path. The cabin is therefore moved to a change position on the second main movement path. When the cabin is in the second main movement path and therefore in the change position, the second device-side coupling component can be coupled to the cabin. This allows a change of the cabin from the first main movement path onto the second main movement path and vice versa. This enables an easy change of the cabin from the first onto the second main movement path and vice versa.

The support arm runs in particular mainly horizontally. It projects away from a wall, in particular an outer wall of the building, and is in particular arranged such that when the cabin is moved along the first main movement path, it projects away from the aforementioned wall at an angle of 90°. The support arm is designed in such a way that the cabin is suspended from the support arm in a coupled state. The first pivot axis is arranged in particular in the vicinity of the aforementioned wall of the building.

In an embodiment of the invention, the first device-side coupling component of the movement device has a holding element which can be coupled to a first cabin-side coupling component of the cabin arranged on a side surface of the cabin and can be pivoted about a vertically running second pivot axis in such a way that a cabin coupled to the first device-side coupling component can be moved from a first main movement path onto a second main movement path. This allows a change of the cabin from the first main movement path onto the second main movement path and vice versa. This enables an easy change of the cabin from the first onto the second main movement path and vice versa.

The holding element has in particular a building-side part and a cabin-side part. The building-side part can be moved along a wall, in particular an outer wall, on a first main movement path, but cannot be moved away from the aforementioned wall. The cabin-side part is connected to the building-side part by a hinge; the aforementioned second pivot axis therefore runs through the hinge. The cabin-side part is coupled to the cabin and can be pivoted by means of a suitable drive from the building-side part and therefore away from the building or toward the building-side part and therefore toward the building. In particular, the aforementioned side surface of the cabin extends mainly vertically.

The second pivot axis is arranged in particular in the vicinity of the aforementioned wall of the building. By the aforementioned pivoting of the cabin-side part of the holding element, a cabin coupled to the cabin-side part of the holding element is moved into a change position in which it can be coupled to a second device-side coupling component.

In an embodiment of the invention, the passenger transport system has an elevator connected to the aforementioned building, by means of which a transport vehicle, in particular without a cabin, can be moved from a delivery level to a storage level. Of course, movement is also possible from the storage level to the delivery level. This allows the safe storage of transport vehicles that have transferred a cabin to the movement device for further movement relative to the building.

A delivery level is understood here to be a level on which the transport vehicle delivers the cabin to the building, i.e. on which the coupling station for changing the cabin from the transport vehicle to the movement device and vice versa is arranged. A storage level is understood here to be a level which is arranged above or, in particular, below the delivery level and on which a transport vehicle can be stored or parked, or at least a storage area or parking space that can be reached by the transport vehicle without further aids. If there is a plurality of storage levels, the aforementioned elevator can also move a transport vehicle to more than one storage level, in particular to all existing storage levels.

In particular, the elevator has an elevator shaft running mainly vertically in which an elevator platform carrying the transport vehicle can be moved. The elevator shaft is arranged in alignment with the first main movement path of the movement device. A transport vehicle standing on the elevator platform can therefore be moved by the elevator directly away from or to a coupling station. The transport vehicle can therefore advantageously be moved from the elevator to a storage level after being uncoupled from a cabin without having to move further. When a transport vehicle is moved by the elevator from the storage level to the delivery level, it is advantageously brought directly to a coupling station.

Without the provision of a second main movement path of the movement device deviating from the first main movement path the provision of the aforementioned elevator can be regarded as an independent invention. This would result in a passenger transport system for a cabin transportable by a transport vehicle for accommodating at least one passenger, wherein the transport vehicle and the cabin can be coupled and uncoupled so that the cabin can be transported by the transport vehicle in a state coupled to the transport vehicle. The passenger transport system would have a movement device connected to a building. The movement device and the cabin would be able to be coupled and decoupled so that the cabin, in a state coupled to the movement device, can be moved by the movement device on a first main movement path relative to the aforementioned building. The passenger transport system would also have an elevator connected to the aforementioned building, by means of which a transport vehicle, in particular without a cabin, can be moved from a delivery level to a storage level.

In an embodiment of the invention, the passenger transport system has a first coupling station and a second coupling station. At the first coupling station, a cabin can be decoupled from a first type of transport vehicle and coupled to the movement device and decoupled from the movement device and coupled to the first type of transport vehicle. At the second coupling station, a cabin can be decoupled from a second type of transport vehicle and coupled to the movement device and decoupled from the movement device and coupled to the second type of transport vehicle. This means that a cabin with one passenger can advantageously be transported by different types of transport vehicles, and a suitable type of transport vehicle can therefore be used for the particular purpose, the particular destination or the available time.

A wide variety of combinations of types of transport vehicles are possible. The first type of transport vehicle can, for example, be designed as an aircraft and the second type as a land vehicle in the form of a road vehicle, a rail vehicle or a watercraft. It is also possible, for example, that the first type is designed as a road vehicle and the second type as a rail vehicle or watercraft. The coupling stations are adapted to the particular type of transport vehicles. The transport system can also have coupling stations for more than two different types of transport vehicles.

Without the provision of a second main movement path of the movement device deviating from the first main movement path the aforementioned provision of two different coupling stations can be regarded as an independent invention. This would result in a passenger transport system for a cabin transportable by a transport vehicle for accommodating at least one passenger, wherein the transport vehicle and the cabin can be coupled and uncoupled so that the cabin can be transported by the transport vehicle in a state coupled to the transport vehicle. The passenger transport system would have a movement device connected to a building. The movement device and the cabin would be able to be coupled and decoupled so that the cabin, in a state coupled to the movement device, could be moved by the movement device relative to the aforementioned building on a first main movement path. The passenger transport system would also have a first coupling station and a second coupling station. At the first coupling station, a cabin could be decoupled from a first type of transport vehicle and coupled to the movement device and decoupled from the movement device and coupled to the first type of transport vehicle. At the second coupling station, a cabin could be decoupled from a second type of transport vehicle and coupled to the movement device and decoupled from the movement device and coupled to the second type of transport vehicle.

The aforementioned object is also achieved by a method for transporting a passenger in a cabin, in which the cabin is coupled to a transport vehicle and transported to a building by the transport vehicle with the passenger. According to the invention, the cabin with the passenger is decoupled from the transport vehicle, coupled to a movement device connected to the building and moved by the movement device relative to the aforementioned building on a first main movement path. The passenger in the cabin is moved by the movement device at least in the direction of his destination within the building. The movement by the movement device also takes place on a second main movement path, wherein the aforementioned main movement paths have different main movement directions. The decoupling from the transport vehicle and the coupling to the movement device takes place at a so-called coupling station and can take place simultaneously, overlapping in time or in any order one after the other.

The passenger can enter the cabin before or after the coupling of the cabin to the transport vehicle. In particular, the coupling and decoupling of the transport vehicle and the movement device takes place automatically without the passenger to be transported having to be active. The necessary action of the aforementioned passenger is limited in particular to specifying a destination to which he wishes to be transported.

If a passenger in a building in a cabin wants to go to a destination outside the building, he enters the cabin and is moved with the cabin by the movement device connected to the building to a coupling station. There, the cabin is coupled to a transport vehicle and decoupled from the movement device. The passenger is then transported with the cabin by the transport vehicle to his destination or at least in the direction of his destination.

In an embodiment of the invention, a method for transporting a passenger in a cabin is proposed in which the cabin is moved onto a secondary movement path of the movement device, wherein the main movement path, from which the aforementioned secondary movement path branches off, remains usable by other cabins. The passenger then leaves the cabin, and the cabin remains on the aforementioned secondary movement path until the next use by a passenger. The cabin is therefore parked on the secondary movement path without the parked cabin restricting the use of the movement device.

The provision of the aforementioned method steps can be regarded as an independent invention even without the movement of the cabin on a second main movement path of the movement device. This would result in a method for transporting a passenger in a cabin, in which method the cabin is coupled to a transport vehicle and transported to a building by the transport vehicle with the passenger. The cabin with the passenger would be decoupled from the transport vehicle, coupled to a movement device connected to the building and moved by the movement device relative to aforementioned building on a first main movement path. The passenger in the cabin would be moved by the movement device at least toward his destination within the building. The cabin would be moved onto a secondary movement path of the movement device, wherein the main movement path from which the aforementioned secondary movement path branches off would remain usable by other cabins. The passenger would then leave the cabin, and the cabin would remain on the aforementioned secondary movement path until the next use by a passenger.

In an embodiment of the invention, a method for transporting a passenger in a cabin is proposed in which the transport vehicle is brought to a storage area after being uncoupled from the cabin and remains in aforementioned storage area until the next use. This allows safe storage of transport vehicles that have transferred a cabin to the movement device for further movement relative to the building.

The storage area can be designed as a parking lot, in particular within the building, which is accessed independently by the transport vehicle.

The provision of the aforementioned method steps can be regarded as an independent invention even without the movement of the cabin on a second main movement path of the movement device. This would result in a method for transporting a passenger in a cabin, in which method the cabin is coupled to a transport vehicle and transported to a building by the transport vehicle with the passenger. The cabin with the passenger would be decoupled from the transport vehicle, coupled to a movement device connected to the building and moved by the movement device relative to aforementioned building on a first main movement path. The passenger in the cabin would be moved by the movement device at least toward his destination within the building. After being uncoupled from the cabin, the transport vehicle would be taken to a storage area and remain there until its next use.

It must be noted that some of the possible features and advantages of the invention are described herein with reference to different embodiments of the passenger transport system according to the invention and the method according to the invention. A person skilled in the art recognizes that the features may be combined, adapted, transferred or exchanged as appropriate in order to yield other embodiments of the invention. In other words, features mentioned for example with reference to the passenger transport system can also be implemented as method steps, and vice versa.

Further advantages, features, and details of the invention can be found in the following description of embodiments and with reference to the drawings, in which like or functionally like elements are provided with identical reference signs. The drawings are merely schematic and are not to scale.

### DESCRIPTION OF THE DRAWINGS

In the figures:

FIG. 1 is a passenger transport system for a transport vehicle and a cabin with a movement device connected to a building,

FIG. 2 is an alternative passenger transport system with a movement device with two coupling stations for different types of transport vehicles for a cabin,

FIG. 3 is a detail of a movement device with a cabin before a change from a first main movement path onto a second main movement path in a plan view,

FIG. 4 is a detail from FIG. 2 in a view from above,

FIG. 5 is the detail from FIG. 3 after the cabin has changed from the first main movement path onto the second main movement path,

FIG. 6 is a detail of an alternative exemplary embodiment of a movement device corresponding to FIG. 3,

FIG. 7 is the detail from FIG. 6 after the cabin has changed from the first main movement path onto the second main movement path,

FIG. 8 is a detail of another alternative exemplary embodiment of a movement device corresponding to FIG. 4,

FIG. 9 is the detail from FIG. 8 after the cabin has changed from the first main movement path onto the second main movement path,

FIG. 10 is a detail of another alternative exemplary embodiment of a movement device with an extension element of the second main movement path in its inactive position,

FIG. 11 is the detail from FIG. 10 with the extension element in its active position,

FIG. 12 is a detail of another alternative exemplary embodiment of a movement device with an alternative extension element of the second main movement element in its inactive position, and

FIG. 13 is the detail from FIG. 12 with the alternative extension element in its active position.

### DETAILED DESCRIPTION

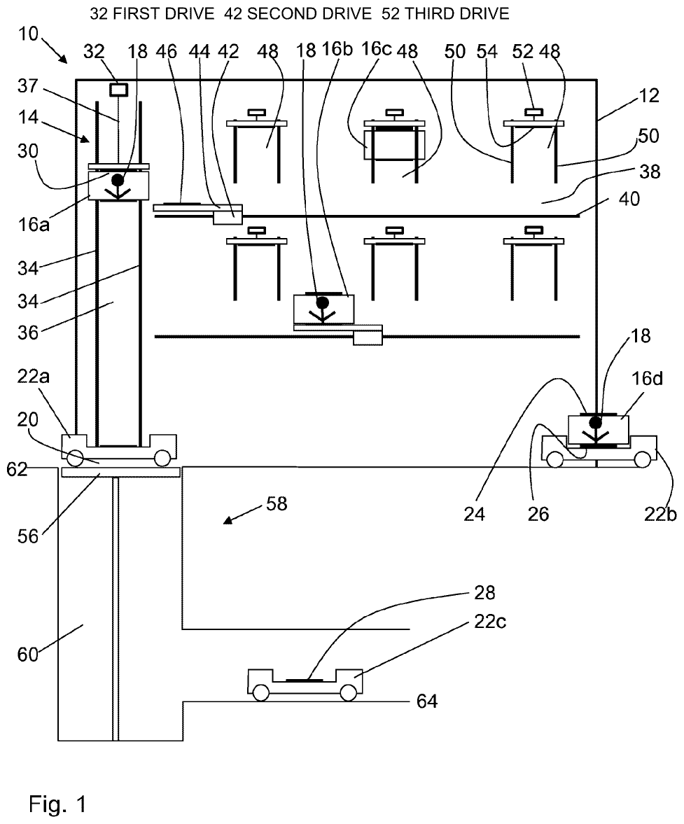

According to FIG. 1, a passenger transport system 10 has a movement device 14 connected to a building 12. By means of the movement device 14, cabins 16a-16d can be moved along the outside of the building 12 and therefore relative to the building 12 in a state coupled to the movement device 14. The identically constructed cabins 16a-16d can accommodate passengers 18 who can be transported in or with the cabins 16a-16d.

A cabin 16a-16d can be coupled to the movement device 14 and decoupled therefrom at a coupling station 20. The cabins 16a-16d can be transported to and from the coupling station 20 using identically designed and electrically powered transport vehicles 22a-22c in the form of autonomous and therefore driverless road vehicles. For this purpose, a cabin 16a-16d can be coupled to one of the transport vehicles 22a-22c and also decoupled again. The particular cabin 16a-16d, in a state coupled to a transport vehicle 22a-22c, can be transported thereby and, in a decoupled state, can be transported or moved independently of a transport vehicle 22a-22c, for example by means of the movement device 14. A passenger 18 can therefore be transported in one of the cabins 16a-16d by one of the transport vehicles 22a-22c to any destination outside the building 12.

The cabins 16a-16d have two cabin-side coupling components in the form of magnetizable metal plates. Each cabin 16a-16d has a first cabin-side coupling component 24 on its upper side and a second cabin-side coupling component 26 on its lower side. The transport vehicles 22a-22c each have a vehicle-side coupling component 28 in the form of a controllable electromagnet. The transport vehicles 22a-22c are designed in such a way that a cabin 16a-16d can be set down from above onto the vehicle-side coupling component 28. If the aforementioned electromagnet of the transport vehicle 22a-22c is activated when the cabin 16a-16d has been set down, it attracts the second cabin-side coupling component 26, therefore establishing a coupling between the transport vehicle 22a-22c and the cabin 16a-16d. In FIG. 1, the transport vehicle 22b is coupled to the cabin 16d and is on the way to the coupling station 20 in order to transfer the cabin 16d to the movement device 14.

The transport vehicle 22a is located at the coupling station 20 without a cabin. It had previously transported the cabin 16a to the coupling station 20 and transferred it to the movement device 14. During the aforementioned transfer of the cabin 16a from the transport vehicle 22a to the movement device 14, the cabin 16a was initially coupled to the transport vehicle 22a as described by means of the second cabin-side coupling component 26 and the vehicle-side coupling component 28.

The movement device 14 has a first device-side coupling component 30 in the form of a controllable electromagnet which is arranged on a frame (not visible in FIG. 1) in such a way that it can be coupled to the first cabin-side coupling component 24. For this purpose, the first device-side coupling component 30 is moved vertically in the direction of the coupling station 20 by means of a first drive 32 in the form of a winch guided by horizontally spaced guide rails 34 until the first device-side coupling component 30 in the form of the electromagnet and the first cabin-side coupling component 24 in the form of the metal plate touch each other or are only at a minimum distance. By activating the electromagnet, a coupling is established between the first device-side coupling component 30 and the first cabin-side coupling component 24 and therefore between the movement device 14 and the cabin 16a. To secure the aforementioned coupling, a mechanical coupling in the form of a form-fit connection can also be established.

After the first device-side coupling component 30 and therefore the movement device 14 were coupled to the cabin 16a, the vehicle-side coupling component 28 and therefore the transport vehicle 22a were decoupled from the cabin 16a by deactivating the aforementioned electromagnet of the transport vehicle 22a. After this decoupling of cabin 16a and transport vehicle 22a, the cabin 16a coupled to the first device-side coupling component 30 could be moved along a vertically running first main movement path 36 defined by guide rails 34. For this purpose, the first drive 32 is connected to the frame holding the first device-side coupling component 30 using a support means 37 in the form of a cable. FIG. 1 shows a state in which the cabin 16a has been moved to a change position in which a change or a transfer of the cabin 16a from the first, vertically running main movement path 36 onto a second, horizontally running main movement path 38 can be carried out.

The second main movement path 38 of the movement device 14 is defined by two rails 40 arranged on a projection of the building 12, of which only one rail is visible in FIG. 1. A second drive 42 in the form of a friction-wheel drive can move back and forth on the rails 40. The second drive 42 is connected to a frame 44 which extends from the second drive 42 in the direction of the first main movement path 36 and carries an upwardly oriented second device-side coupling component 46 in the form of an electromagnet. The frame 44 and the second device-side coupling component 46 are arranged in such a way that, by moving the second drive 42 in the direction of the first main movement path 36, the second device-side coupling component 46 extends into the first main movement path 36 in such a way that it is arranged below the second cabin-side coupling component 26. The cabin 16a can therefore be set down by the first drive 32 on the second device-side coupling component 46. Subsequently, by activating the second device-side coupling component 46 in the form of the electromagnet, a coupling of the second device-side coupling component 46 to the second cabin-side coupling component 26 and therefore to the cabin 16a is established. After the coupling of the second device-side coupling component 46 to the cabin 16a, the coupling of the first device-side coupling component 30 to the cabin 16a is released, and the cabin 16a can be moved horizontally on the second main movement path 38 by means of the second drive 42. The described change of the cabin 16a from the first main movement path 36 onto the second main movement path 38 can also be referred to as a transfer of the cabin from the first onto the second main movement path.

A total of three secondary movement paths 48, arranged horizontally offset next to one another, branch off vertically upward from the second main movement path 38. The three secondary movement paths 48 are each defined by two vertically running and horizontally spaced guide rails 50. By means of a third drive 52, a third device-side coupling component 54 can be moved vertically along the guide rails 50. The third drive 52 and the third device-side coupling component 54 are basically constructed identically to the first drive 32 and to the first device-side coupling component 30 so that their mode of operation is also identical. The third device-side coupling component 54 can therefore also be coupled to a first cabin-side coupling component 24 and therefore to a cabin 16a-16d. For this purpose, the cabin 16a-16d must be moved by means of the second drive 42 into a position aligned with a secondary movement path 48. Subsequently, the third device-side coupling component 54 can be brought into a position by means of the third drive 52 in which a coupling can be established with the first cabin-side coupling component 24 and therefore with the cabin 16a-16d. After this coupling has been established, the cabin 16a-16d is decoupled from the second device-side coupling component 46, and the cabin 16a-16d can be moved upward on the secondary movement path 48 and therefore out of the second main movement path 38 into a parking position by means of the third drive 52. The cabin 16c in FIG. 1 is in such a parking position from which direct access to an apartment or other destination in the building 12 of the passenger 18 is possible. If a cabin 16a-16d is in such a parking position on a secondary movement path 48, the second main movement path 38, from which the secondary movement path 48 branches off, can be used by another cabin 16a-16d. The secondary movement paths 48 are therefore designed and arranged in such a way that they can accommodate a cabin 16a-16d and that the second main movement path 38, from which the corresponding secondary movement path 48 branches off, can be used by another cabin 16a-16d when a cabin 16a-16d is accommodated on the corresponding secondary movement path 48.

Below the described second main movement path 38, an identically constructed second main movement path also with three secondary movement paths is arranged. In the state shown in FIG. 1, the car 16b is moved on this second main movement path to a secondary movement path in order to be brought into its parking position there.

One or more secondary movement paths can also branch off from the first, in particular vertical, main movement path.

When a passenger 18 from the building 12 wants to reach a destination outside the building 12 in a cabin 16a-16d, he leaves the building 12, for example his apartment, and gets into a cabin 16a-16d arranged at a corresponding parking position and is moved with the cabin 16a-16d via the corresponding secondary movement path 48, the corresponding second main movement path 38 and the first main movement path 36 into the coupling station 20 and transferred to a transport vehicle 22a-22c. The couplings and decouplings between the individual coupling components mainly take place in the reverse order to the above-described movement of a cabin 16a-16d from the coupling station 20 to a parking position in a secondary movement path 48.

When a transport vehicle such as the transport vehicle 22a in FIG. 1 is located in the coupling station 20, it stands on an elevator platform 56 of an elevator 58. The elevator 58 has a vertically running elevator shaft 60 in which the elevator platform 56 can be moved vertically by means of a drive not shown in detail, for example a hydraulic drive. The elevator shaft 60 is arranged in alignment with the first main movement path 36 of the movement device 14. A transport vehicle standing on the elevator platform 56 can therefore be moved by the elevator 58 directly away from the coupling station 20 or to the coupling station 20.

A transport vehicle 22a-22c can be moved by the elevator 58 from a delivery level 62, on which the coupling station 20 is arranged, to a storage level 64 and vice versa. The storage level 64 can also be considered as a storage area. On the storage level 64 on which the transport vehicle 22c is located in the state shown in FIG. 1, a transport vehicle 22a-22c can drive to a parking area (not shown) and wait there for its next deployment, i.e. until the next use. The parking area can also be referred to as a storage area. For example, batteries of the transport vehicle 22a-22c can be charged there. If a transport vehicle 22a-22c located on the aforementioned parking lot is to transport a cabin 16a-16d, it then drives onto the elevator platform 56 positioned on the movement level 64 and can be moved by the elevator 58 to the coupling station 20 where it can be coupled to a cabin 16a-16d.

The cabins 16a-16d, the transport vehicles 22a-22c, the movement device 14 and the elevator 58 have control devices (not shown) which are in communication with a central control device (also not shown). The central control device sends tasks to the individual control devices which then implement them automatically. A passenger 18 who wishes to be transported in a cabin 16a-16d only has to communicate his destination and, if applicable, his location to the central control device, for example via a smart phone. The central control device converts this transport request into tasks for the involved components. The distribution of tasks between the central control device and the individual control devices can be chosen arbitrarily.

It is also possible for not only identical but also different transport vehicles to be used. The transport vehicles can differ in their design, their size, their type of drive or even their type, for example road vehicles and rail vehicles. It is also possible to use not only identical cabins. The movement device can be designed in such a way that it can move different cabins. However, it is also possible for there to be different movement devices for different cabins. Other types of couplings between the cabin and the transport vehicle and the cabin and the movement device, as well as other drives for the movement device, are also possible. The described elevator for the transport vehicles, as well as the second main movement paths, are not absolutely necessary.

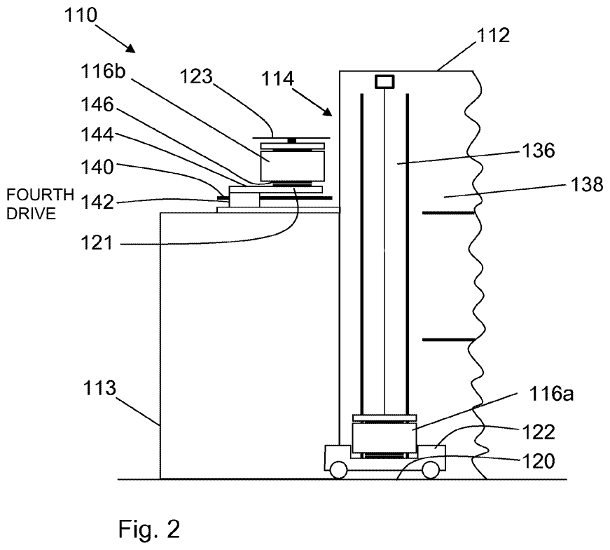

The passenger transport system 110 shown in FIG. 2 is structured similarly to the passenger transport system 10 from FIG. 1, which is why only the differences between the passenger transport systems 10 and 110 are addressed. The passenger transport system 110 in FIG. 2 also has a movement device 114 connected to a building 112, wherein only a part of the building 112 and the movement device 114 is shown in FIG. 2. The passenger transport system 110 does not have an elevator for transport vehicles. It has two coupling stations, with a first coupling station 120 being identical to the coupling station 20 from FIG. 1. At the first coupling station 120, a transfer of a cabin 116a from a transport vehicle 122 in the form of a road vehicle to the movement device 114 and vice versa can therefore take place, as described with reference to FIG. 1. Such a road vehicle therefore represents a first type of transport vehicle.

A second coupling station 121 is arranged on a roof of an extension 113 to the building 112. The second coupling station 121 is provided to enable a transfer of a cabin 116b to the movement device 114. For this purpose, horizontally running rails 140 are arranged on the extension 113, on which a fourth drive 142 together with a frame 144 and a coupling component 146 are moved horizontally. The rails 140, the fourth drive 142, the frame 144 and the coupling component 146 are designed analogously to the rails 40, the second drive 42, the frame 44 and to the second device-side coupling component 46, and function accordingly. The coupling component 146 can thus be moved onto the first main movement path 136 of the movement device 114.

The cabin 116b can therefore be transported through the air by a transport vehicle 123 in the form of a drone to the second coupling station 121 and placed on the coupling component 146. Such a drone therefore represents a second type of transport vehicle. The cabin 116b is then moved onto the first main movement path 136 and coupled to the movement device 114 as described in connection with FIG. 1. The cabin 116b is then decoupled from the coupling component 146, and the coupling component 146 is moved out of the first main movement path 136, whereby the cabin 116b can be moved by the movement device 114 relative to the building 112. A transfer of a cabin 116a, 116b from the movement device 114 to a transport vehicle 123 in the form of a drone takes place in the reverse order.

It is also possible for the transport vehicle in the form of a drone to transport the cabin directly to the first main movement path and couple it there to the movement device. This is also possible if cabins are transported to the movement device and from it by only one type of transport vehicle in the form of drones. In this case, a cabin can be set down by a drone from above on a first device-side coupling component of the movement device.

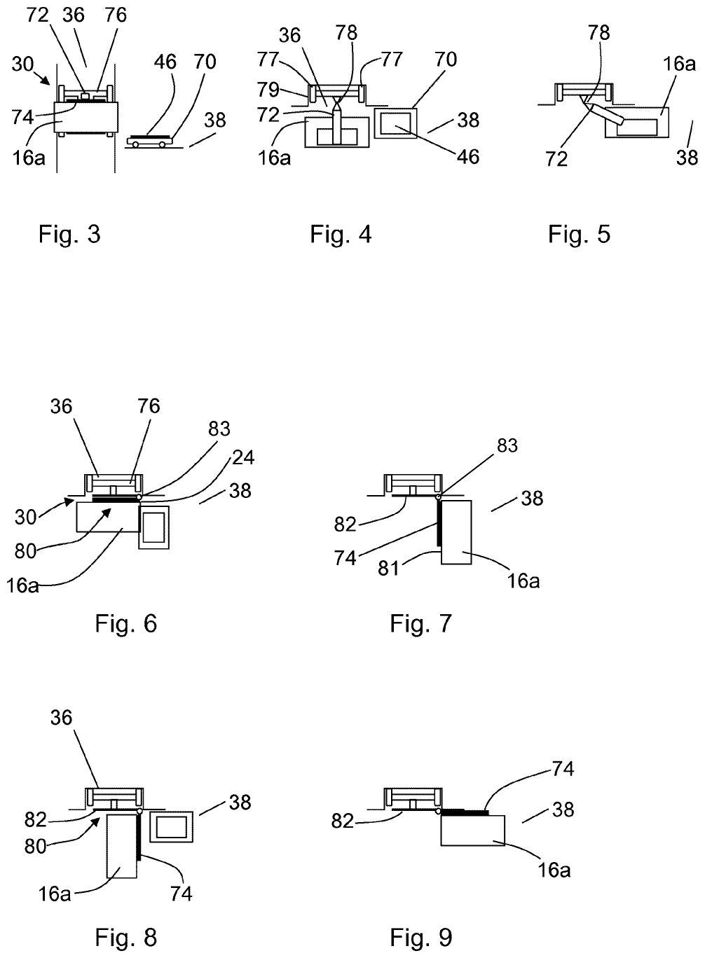

The following FIGS. 3-13 relate to all the components necessary for transferring a cabin 16a from the first main movement path 36 onto the second main movement path 38 of a movement device connected to a building. For this reason, only a section of the first main movement path 36 and of the second main movement path 38 with the components arranged there is shown. The coupling components for coupling a cabin to the movement device are identical to the passenger transport system in FIG. 1, which is why they will not be discussed further.

According to FIGS. 3, 4 and 5, the movement device has a trolley 70—with its own drive (not shown)—which can move on the second main movement path 38 which is designed as a projection on the building. The trolley 70 has a second device-side coupling component 46 which is identical to that in FIG. 1. This allows the cabin 16a to be set down on the trolley 70 from above, the trolley 70 and the cabin 16a to be coupled, and then the cabin 16a to be moved from the trolley 70 onto the second main movement path 38.

The first device-side coupling component 30 has a mainly horizontally running support arm 72 which connects the electromagnet 74 to a frame 76. When being moved along the first main moving path 36, the frame 76 rolls on rollers 77 into a niche 79 of the building and is guided in this niche 79. The support arm 72 can be pivoted about a vertically running pivot axis 78, wherein the pivot axis 78 runs in the niche 79.

In FIGS. 3 and 4, the cabin 16a is located on the first main movement path 36, with FIG. 3 showing a plan view and FIG. 4 showing a view from above. In order to transfer the cabin 16a from the first main movement path 36 onto the second main movement path 38, the support arm 72 is pivoted about the pivot axis 78 in the direction of the second main movement path 38 by a drive (not shown) until the cabin 16a is arranged above the trolley 70 and can therefore be placed on the trolley 70 and coupled thereto. This state is shown in FIG. 5 in a view from the above. The transfer of a cabin 16a from the second main movement path 38 onto the first main movement path 36 takes place in the reverse order.

The components shown in FIGS. 6 and 7 differ from those in FIGS. 4 and 5 only in the orientation of the first electromagnet 74 of the first device-side coupling component 30, in its connection to the frame 76, as well as in the orientation and arrangement of the first cabin-side coupling component 24. In FIG. 6, the cabin 16a is located on the first main movement path 36 and, in FIG. 7, on the second main movement path 38.

The first device-side coupling component 30 has a holding element 80 which can be coupled to the first cabin-side coupling component 24 arranged on a mainly vertically extending side surface 81 of the cabin 16a. The holding element 80 has a building-side part 82 and a cabin-side part in the form of the electromagnet 74. The building-side part 82 is immovably connected to the frame 76. The electromagnet 74 is connected by a hinge 83 to the building-side part 82. When the cabin 16a is located on the first main movement path 36, the two parts 74, 82 of the holding element 80 are arranged parallel to each other. The electromagnet 74 can be pivoted by 90°about a vertical pivot axis running through the hinge 83. The electromagnet 74 coupled to the cabin 16a can be pivoted by a drive (not shown) from the building-side part 82 and therefore away from the building, or pivoted toward the building-side part 82 and therefore toward the building.

This allows the cabin 16a to be moved and therefore transferred from the first main movement path 36 onto the second main movement path 38 and vice versa.

The components shown in FIGS. 8 and 9 differ from those in FIGS. 6 and 7 only in the arrangement of the two parts of the holding element 80 relative to one another. In FIG. 8, the cabin 16a is located on the first main movement path 36. In this exemplary embodiment, the electromagnet 74 and the building-side part 82 form an angle of 90°, with the electromagnet 74 being oriented away from the building. In FIG. 9, the cabin 16a is located on the second main movement path 38. The electromagnet 74 and the building-side part 82 of the holding element 80 form an angle of 180°.

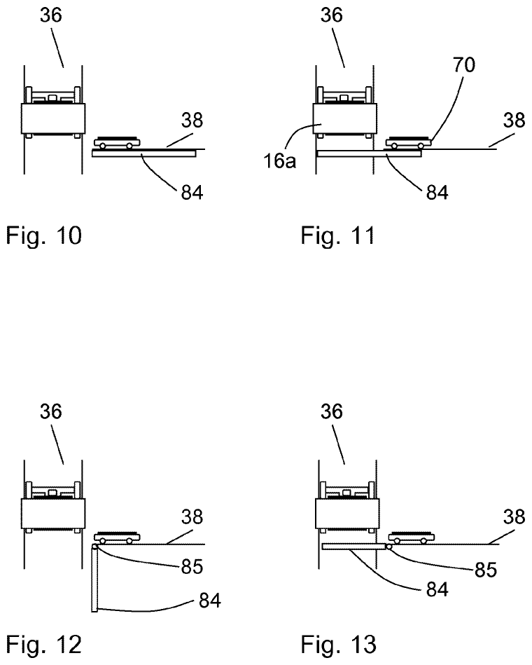

In FIGS. 10 and 11, an exemplary embodiment is shown in which the second main movement path 38 has a movable extension element 84 in the form of a plate. The extension element 84 is designed and arranged in such a way that the second main movement path 38 can be extended into the first main movement path 36 by means of the extension element 84.

In FIG. 10, the extension element 84 is shown in its inactive position in which it does not extend the second main movement path 38 into the first main movement path 36. In this inactive position, the extension element 84 is arranged below the second main movement path 38. By a horizontal displacement of the extension element 84 in the direction of the first main movement path 36 by means of a drive (not shown), the extension element 84 is brought into its active position shown in FIG. 11. In this active position of the extension element 84, the trolley 70 can be moved under the cabin 16a via the extension element 84. The cabin 16a can then be placed on the trolley 70 and coupled thereto so that it can be moved by the trolley 70 onto the second main movement path 38. As soon as the cabin 16a has been moved off the first main movement path 36, the extension element 84 is returned to its inactive position so that the first main movement path 36 can be used for moving another cabin. A transfer of a cabin 16a from the second main movement path 38 onto the first main movement path 36 takes place in the reverse order.

FIGS. 12 and 13 show another exemplary embodiment which is very similar to the exemplary embodiment shown in FIGS. 10 and 11. The only difference is that the extension element 84 is connected to the second main movement path 38 via a hinge 85 oriented horizontally and transversely to the second main movement path 38. As shown in FIG. 12, the extension element 84 runs vertically downward in its inactive position and can be brought into its active position shown in FIG. 13, in which it projects into the first main movement path 36, by pivoting about the aforementioned hinge 85.

Finally, it should be noted that terms such as “having,” “comprising,” etc. do not preclude other elements or steps, and terms such as “a” or “an” do not preclude a plurality. Furthermore, it should be noted that features or steps which have been described with reference to one of the above exemplary embodiments may also be used in combination with other features or steps of other exemplary embodiments described above.

In accordance with the provisions of the patent statutes, the present invention has been described in what is considered to represent its preferred embodiment. However, it should be noted that the invention can be practiced otherwise than as specifically illustrated and described without departing from its spirit or scope.

1-14. (canceled)

15. A passenger transport system for transporting a passenger outside a building and relative to the building, the passenger transport system comprising:
a cabin adapted to accommodate a passenger;
a transport vehicle adapted to transport the cabin outside the building;
a first coupling selectively coupling the cabin to the transport vehicle and decoupling the cabin from the transport vehicle;
a movement device connected to the building and adapted to move the cabin relative to the building on a first main movement path;
a second coupling selectively coupling the cabin to the movement device and decoupling the cabin from the movement device; and
wherein the movement device is adapted to move the cabin on a second main movement path, the first main movement path and the second main movement path having different cabin movement directions.

16. The passenger transport system according to claim 15 wherein the movement device is adapted to move the cabin on a secondary movement path, the secondary movement path branching off from the second main movement path, and the secondary movement path being adapted to accommodate the cabin decoupled from the movement device enabling another cabin to be moved relative to the building on the second main movement path.

17. The passenger transport system according to claim 16 wherein the movement device includes a first drive and a second drive, the second coupling has a first device-side coupling component and a second device-side coupling component, the first drive moves the first device-side coupling component on the first main movement path, the second drive moves the second device-side coupling component on the second main movement path, the first device-side coupling component couples to and decouples from a first cabin-side coupling component of the cabin, and the second device-side coupling component couples to and decouples from a second cabin-side coupling component of the cabin.

18. The passenger transport system according to claim 17 wherein the movement device has a third drive, the second coupling has a third device-side coupling component, the third drive moves the third device-side coupling component on the secondary movement path, and the third device-side coupling component couples to and decouples from the first cabin-side coupling component of the cabin.

19. The passenger transport system according to claim 15 wherein the movement device includes a trolley adapted to support the cabin and move on the second main movement path in a horizontal direction.

20. The passenger transport system according to claim 15 wherein the second main movement path has a movable extension element, the extension element adapted to selectively extend into the first main movement path enabling a change of the cabin from the first main movement path onto the second main movement path and vice versa.

21. The passenger transport system according to claim 15 wherein the second coupling has a first device-side coupling component, the first device-side coupling component including a support arm adapted to couple to a first cabin-side coupling component of the cabin arranged on an upper side of the cabin or on an underside of the cabin, the support arm being pivotable about a vertically running pivot axis such that the cabin coupled to the first device-side coupling component is moved from the first main movement path onto the second main movement path enabling a change of the cabin from the first main movement path onto the second main movement path and vice versa.

22. The passenger transport system according to claim 15 wherein the second coupling has a first device-side coupling component, the first device-side coupling component including a holding element adapted to couple to a first cabin-side coupling component of the cabin arranged on a side surface of the cabin, the holding element being pivotable about a vertically running pivot axis such that the cabin coupled to the first device-side coupling component is moved from a first main movement path onto a second main movement path enabling a change of the cabin from the first main movement path onto the second main movement path and vice versa.

23. The passenger transport system according to claim 15 including an elevator connected to the building and adapted to move the transport vehicle from a delivery level of the building to a storage level of the building.

24. The passenger transport system according to claim 23 where in the elevator has an elevator shaft in which an elevator platform adapted to carry the transport vehicle moves vertically along the first main movement path.

25. The passenger transport system according to claim 15 wherein the transport vehicle is a first type transport vehicle, including a first coupling station at which the cabin is decoupled from the first type transport vehicle and coupled to the movement device and is decoupled from the movement device and coupled to the first type transport vehicle, and a second coupling station at which the cabin is decoupled from a second type transport vehicle and is coupled to the movement device and is decoupled from the movement device and coupled to the second type transport vehicle.

26. A method for transporting a passenger in a cabin, the method comprising steps of:
coupling the cabin to a transport vehicle and transporting by the transport vehicle the passenger in the cabin to a building;
decoupling the cabin with the passenger from the transport vehicle, coupling the cabin to a movement device connected to the building and moving the cabin with the passenger by the movement device relative to the building on a first main movement path;
moving the cabin with the passenger by the movement device relative to the building on a second main movement path, the first main movement path and the second main movement path having different cabin movement directions.

27. The method according to claim 26 including steps of moving the cabin with the passenger onto a secondary movement path that branches off the second main movement path wherein the second main movement path remains usable by other cabins, the passenger leaving the cabin, and the cabin remaining on the secondary movement path until a next use.

28. The method according to claim 27 including bringing the transport vehicle to a storage level of the building after being decoupled from the cabin, the transport vehicle remaining on the storage level until a next use.
